(19) United States
(12) Patent Application Publication
(10) Pub. No.: US 2017/0142228 A1
(43) Pub. Date: May 18, 2017

(54) SERVER CLUSTER PATCH TRACKING TO FACILITATE CODE LEVEL MATCHING OF ADDED SERVERS

(71) Applicant: International Business Machines Corporation, Armonk, NY (US)

(72) Inventors: Alan Byrne, Leixlip (IE); Michael D. Gazda, Durham, NC (US); Marshall A. Lamb, Raleigh, NC (US); Bryan D. Osenbach, Cary, NC (US)

(21) Appl. No.: 14/938,920

(22) Filed: Nov. 12, 2015

(51) Int. Cl. H04L 29/08; H04L 12/24

(52) U.S. Cl. CPC H04L 67/34; H04L 41/0813

(57) ABSTRACT

One or more processors track one or more patch states of one or more servers in a server cluster. One or more processors select one or more patches to be applied to a first server based on a tracked patch state for the one or more servers in the server cluster to which the first server is to join. One or more processors apply the one or more patches to the first server before the first server is joined to the one or more servers in the server cluster.

### BACKGROUND OF THE INVENTION

The present invention relates generally to the field of server patching and more particularly to server cluster patch tracking in order to update provisioned servers.

A server cluster is a group of independent servers working together as a single system to provide improved capability, availability and reliability compared with operating a single server. The use of a server cluster provides back-up against software or hardware failures at a first server thereby improving the function provided by the first server. In a server cluster, each individual server typically has a copy of the operating system and the applications or services that the cluster is managing. Server clusters may be used as file servers, print servers, web servers, database servers, and messaging servers for example.

Server provisioning is a process of preparing a server with appropriate software and data to make it ready for it to perform its intended function within a network. Server provisioning tasks may include loading appropriate software (operating system, drivers, applications etc.) and configuring hardware and software settings and parameters. The automation of the provisioning of servers in a distributed system is a common practice.

### SUMMARY

Embodiments of the present invention provide a method, system, and program product to track server cluster patching to update newly provisioned servers. One or more processors track one or more patch states of one or more servers in a server cluster. One or more processors select one or more patches to be applied to a first server based on a tracked patch state for the one or more servers in the server cluster to which the first server is to join. One or more processors apply the one or more patches to the first server before the first server is joined to the one or more servers in the server cluster.

### BRIEF DESCRIPTION OF THE SEVERAL VIEWS OF THE DRAWINGS

FIG. 1 is a functional block diagram illustrating a patch tracking environment, in accordance with an exemplary embodiment of the present invention.

FIG. 2 schematically illustrates post-provisioning patches being applied to servers within a cluster in accordance with an embodiment of the present invention.

FIG. 3 schematically illustrates, in accordance with an embodiment of the present invention, the patching of a new server prior to it being permitted to join the server cluster of FIG. 2.

FIG. 4 schematically illustrates a table setting out patch update records for a series of servers in accordance with an embodiment of the present invention.

FIG. 5 is a schematic block diagram of the functional processing modules within a patch tracking program that perform the patch tracking and updating process in accordance with an embodiment of the present invention.

FIG. 6 illustrates operational processes of a patch tracking program utilizing a patch state database, on a computing device within the environment of FIG. 1, in accordance with a first exemplary embodiment of the present invention.

FIG. 7 illustrates operational processes of a patch tracking program utilizing a patch state database, on a computing device within the environment of FIG. 1, in accordance with a second exemplary embodiment of the present invention.

FIG. 8 depicts a block diagram of components of the computing device executing a patch tracking program, in accordance with an exemplary embodiment of the present invention.

### DETAILED DESCRIPTION

Embodiments of the present invention recognize that newly provisioned servers may not match the code level of servers to which they will be joined in a server cluster. Embodiments of the present invention provide a method, computer-readable medium, and system enabling the automatic updating of newly provisioned servers with a patch state matching a server cluster to which the newly provisioned servers will join.

When a new server is provisioned for use in a server cluster, it is desirable that the newly provisioned server should match the code level of other servers in a cluster before it is joined to the cluster. In a system where servers can receive patches outside the provisioning process, the automated provisioning may miss these post-provision patches and a newly provisioned server may require manual intervention before it can go live or join the server cluster. Such manual intervention introduces a potential for error.

The present invention will now be described in detail with reference to the Figures.

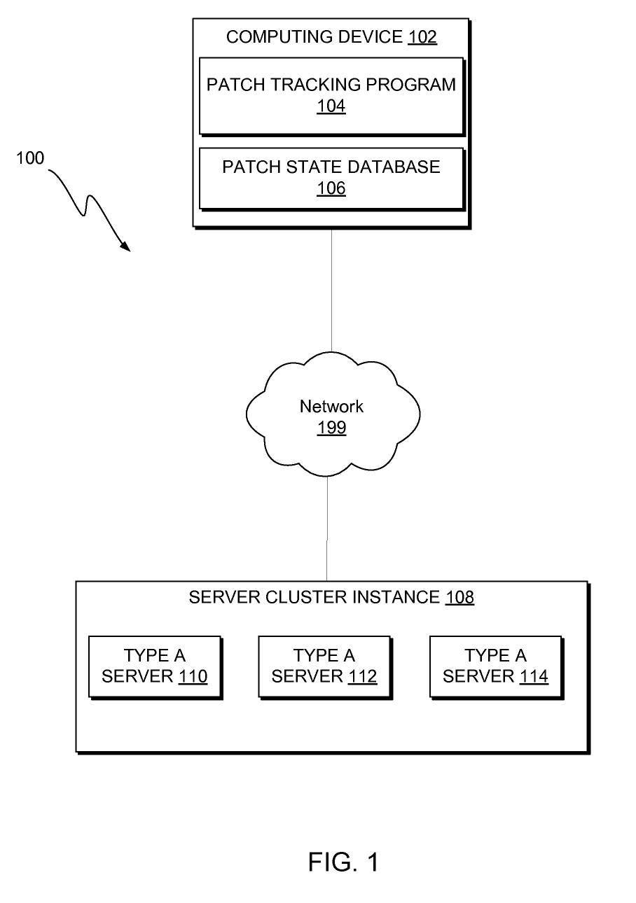

FIG. 1 is a functional block diagram illustrating a patch tracking environment, generally designated 100, in accordance with one embodiment of the present invention. Patch tracking environment 100 includes computing device 102 and server cluster instance 108 connected over network 199. Computing device 102 includes patch tracking program 104 and patch state database 106. Server cluster instance 108 includes type A servers 110, 112, and 114.

In various embodiments of the present invention, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to patch tracking program 104, patch state database 106, and servers such as type A servers 110, 112, and 114, and is capable of executing patch tracking program 104. Computing device 102 may include internal and external hardware components, as depicted and described in further detail with respect to FIG. X.

In this exemplary embodiment, patch tracking program 104 and patch state database 106 are stored on computing device 102. However, in other embodiments, patch tracking program 104 and patch state database 106 may be stored externally and accessed through a communication network, such as network 199. Network 199 can be, for example, a local area network (LAN), a wide area network (WAN) such as the Internet, or a combination of the two, and may include wired, wireless, fiber optic or any other connection known in the art. In general, network 199 can be any combination of connections and protocols that will support communications between patch tracking program 104, patch state database 106, and servers such as type A servers 110, 112, and 114, in accordance with a desired embodiment of the present invention.

In exemplary embodiments, patch tracking program 104 tracks patches applied to server clusters such as server cluster 108. Patch tracking program 104 applies the appropriate patches to any newly provisioned server that is set to join the server cluster so that the newly provisioned server matches the code level of the server cluster.

In exemplary embodiments, patch state database 106 stores the current patch state of server clusters such as server cluster 108. Patch state database 106 provides tables showing the patch state of the server cluster and enables patching of a newly provisioned server of a matching type so that the newly provisioned server matches the code level of the server cluster to which it will join.

In exemplary embodiments, server cluster instance 108 is one or more servers providing one or more services to clients. At any point in time, server cluster 108 includes a patch state that is the result of patches applied by, for example, an administrator or periodic update service of the server cluster. The patch state includes all data required to update a newly provisioned server with the patches necessary to match the code level of the current instance of server cluster instance 108.

In exemplary embodiments, type A servers 110, 112, and 114 represent any server cluster that includes one or more servers that serve clients for a particular function. As depicted in FIG. 1, server cluster instance 108 is an example of a server cluster instance that includes three servers. In various embodiments of the present invention, server cluster includes any number of servers that are necessary for server cluster 108 to provide satisfactory service to clients requiring the particular function that service cluster 108 provides. The particular function provided by server clusters such as server cluster 108 is indicated by the server type. Server types include web servers, file servers, printer servers, database servers, messaging servers, etc. It is understood that embodiments of the present invention are not limited to the aforementioned types. Instead, the aforementioned server types are examples of types of functions that server cluster instance 108 and its servers (i.e., type A servers 110, 112, and 114) provide to clients of server cluster instance 108.

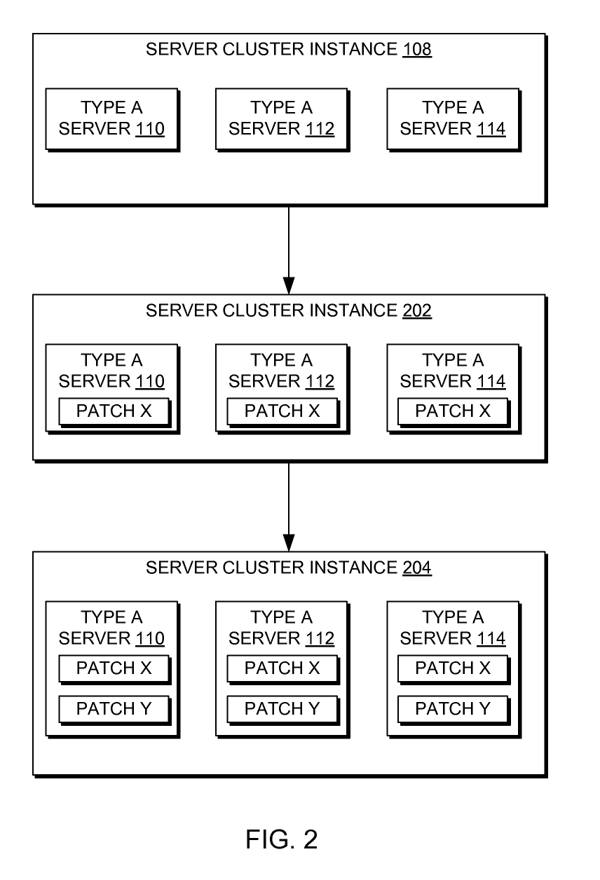

FIG. 2 schematically illustrates post-provisioning patches being applied to servers within a cluster in accordance with an embodiment of the present invention.

Server cluster instance 108 represents a server cluster with three type A servers 110, 112, and 114. The three servers in server cluster instance 108 are provisioned and operating to serve clients. The three type A servers 110, 112, and 114 provide the same service (relating to their role) through a load balancer. In various embodiments, the three type A servers 110, 112, and 114 each and together provide, for example, the following types of server clusters: a web server cluster, a file server cluster, a print server cluster, a database server cluster, or a messaging server cluster, or any other type of server cluster require periodic patching.

At one point a patch X is applied to type A servers 110, 112, and 114 to provide the patch state of server cluster instance 202. Later on, a further patch Y is applied to type A servers 110, 112, and 114 to provide the patch state of server cluster instance 204. Patch tracking program 104 tracks and records the patches being applied to all servers (not just those in this cluster) as a patch state, and in particular in the present case monitors the application of patches to the type A servers 110, 112, and 114. In one embodiment, the patched server itself alerts patch tracking program 104 that it has been patched. In another embodiment, an entity applying the patch alerts patch tracking program 104 of which servers have been patched. In any case, the monitoring of applied patches results in patch tracking program 104 recording in patch state database 106 that all A type servers have patches X and Y applied, and in that order. In various embodiments, patch tracking program 104 is, as will be described in detail below, integrated into the provisioning flow for new servers.

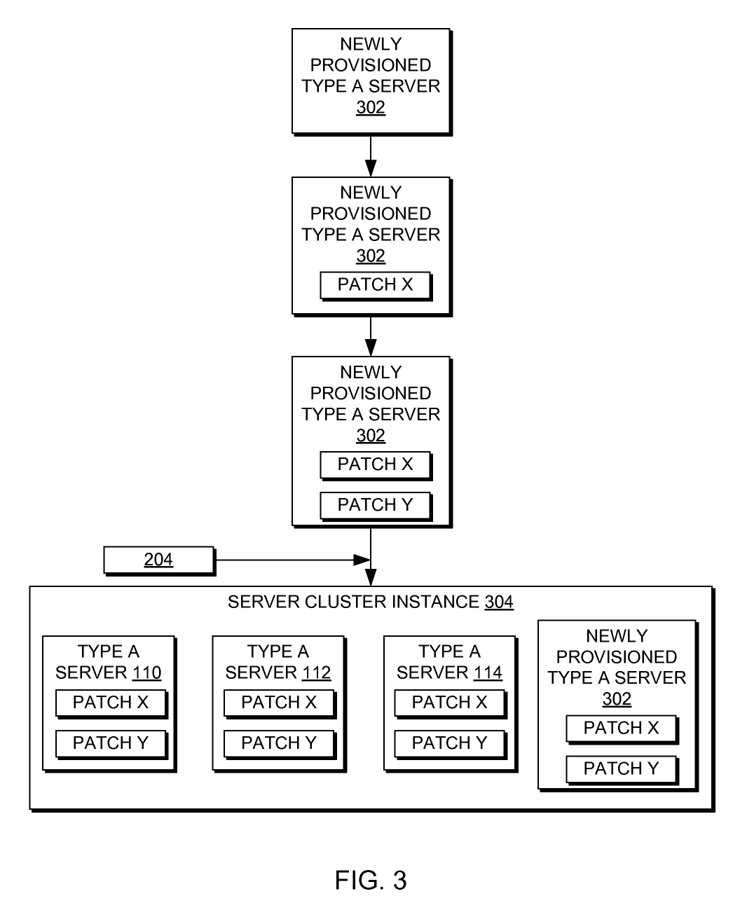

FIG. 3 schematically illustrates, in accordance with an embodiment of the present invention, the patching of a new server prior to it being permitted to join the server cluster of FIG. 2.

FIG. 3 shows how a newly provisioned type A server is patched and joined to server cluster instance 204 to provide server cluster instance 304. Prior to patching by patch tracking program 104, newly provisioned type A server 302 was provisioned with the appropriate software, data, configuration and settings required to perform its service as a type A server. Once the provisioning stage 10 is completed, a patching stage is commenced, under the control of the patch tracking program 104, in which a check is made with patch state database 106 of whether there are any patches that have been applied to type A servers 110, 112, and 114 in server cluster instance 204 so that the same patches can be applied to newly provisioned type A server 302. In one embodiment, the provisioning system responsible for provisioning newly provisioned type A server 302 tells patch tracking program 104 that a new node of type A has been provisioned. Patch tracking program 104 identifies from patch state database 106 that A type servers have patches X and Y applied and so triggers the application of those patches, in that order, to newly provisioned type A server 302. Newly provisioned type A server 302 now matches type A servers 110, 112, and 114 for code level and so can be safely added to server cluster instance 204 to provide server cluster instance 304. Following the patching and joining stages, the newly expanded server cluster (server cluster instance 304) goes live.

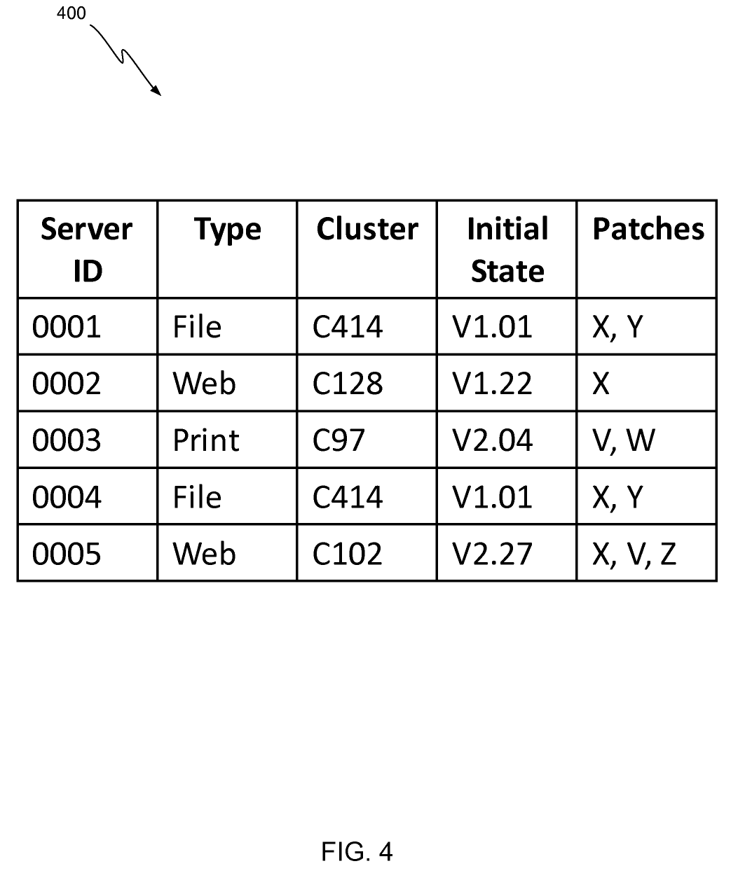

FIG. 4 schematically illustrates a table, 400, setting out patch update records for a series of servers in accordance with an embodiment of the present invention.

In an embodiment, example patch record table 400 is used to store information (patch state) regarding the patch history of servers within one or more server clusters. The example table includes five columns. The first column stores a server ID, which is a unique identifier for each server in which patch tracking program 104 is monitoring. The second column stores a type of the server, for example, a web server, file server, print server or messaging server. In an embodiment, the table differentiates between different variants of a type (either using the type column or field, or by utilizing a different column/field). For example, in a case where there is more than one distinct type of file server, each type requiring a different pattern of patches. The third column stores an indication of a server cluster to which the server belongs, enabling patch tracking program 104 to determine the patch level of existing servers within a server cluster to which a newly provisioned server is to be joined. The fourth column stores an initial software state of the server effectively defining a baseline upon which patches build. The fifth column stores a sequence of patches which have been applied (in order) to that server.

Five example records/rows are shown in table 400 each having a unique server ID. The first (server ID 0001) and fourth (server ID 0004) entries define servers having a file server role, and belonging to the same cluster C414. The second (server ID 0002) and fifth (server ID 0005) entries define servers in separate clusters but both having a web server role. The third entry (server ID 0003) defines a server having a print server role. It will be appreciated that servers within the same cluster can be expected to have the same role, and to be patched to the same code level. Generally, it could be expected that each server in the same cluster would have the same initial state (as is the case with the first and fourth entries in table 400) and the same sequence of patches applied thereto. However, in some cases two servers within the same server cluster may have different initial states, and different patch sequences. For example, one of the servers has a provisioned state which already included the functionality of an earlier patch (which was thus not required to be applied subsequent to provisioning).

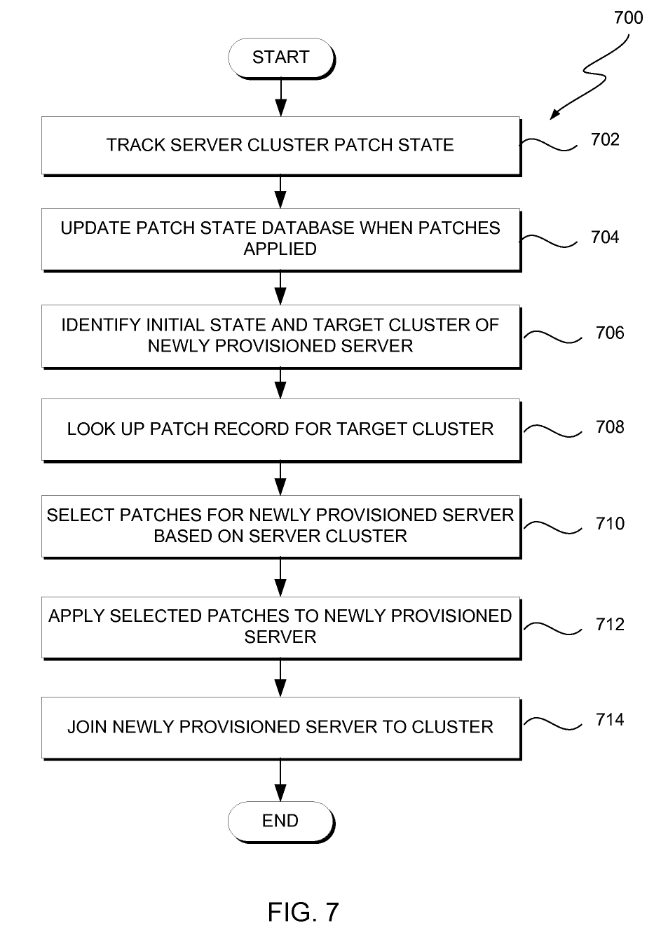

It will be appreciated that table 400 includes one entry for each server being tracked by the patch tracking program 104. In another embodiment, it may be possible for such a table to have only a single entry per server cluster (based on an assumption that all servers within a given cluster will have a common patch sequence). In this case, determining a sequence of patches to be applied to a newly provisioned server is achieved by looking up in the patch record table a sequence of patches associated with a server cluster to which the newly provisioned server is to be joined to. An example process for this is explained with reference to FIG. 7 below. In yet another embodiment, the table includes a single entry for each server type, or alternatively, a single entry for each unique combination of server type and initial state. In this case, the patch state of individual servers is not tracked, but instead patch tracking program 104 tracks more generally when particular classes of server (for example a file server having an initial state of V1.01) are being patched.

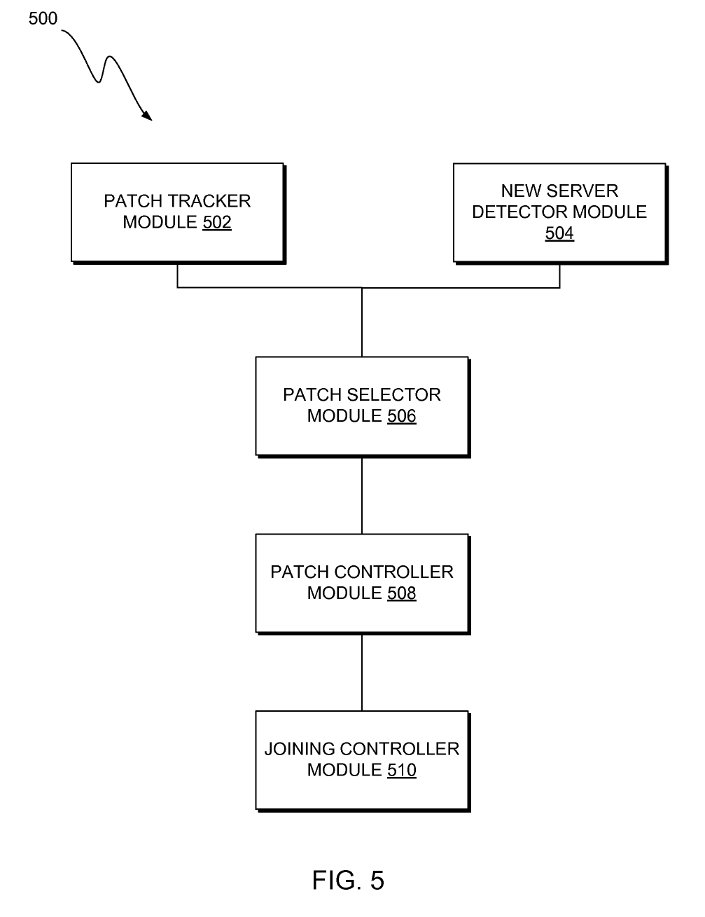

FIG. 5 is a schematic block diagram, generally designated 500, of the functional processing modules within a patch tracking program that perform the patch tracking and updating process in accordance with an embodiment of the present invention.

The patch tracking program 104 includes patch tracker module 502 which monitors the application of software patches to existing (previously provisioned) servers. It will be appreciated that patch tracker module 502 is capable of being responsible for tracking patches applied to a large number of servers within many clusters, and relating to many different roles. New server detector module 504 identifies when a new server has been newly provisioned. In one embodiment, this detection is based on a notification from a provisioning system which has provisioned the new server. Patch selector module 506 selects a sequence of patches which need to be applied to the newly provisioned server in order for it to be consistent in code level with existing servers in a server cluster to which the newly provisioned server is to be joined. The selection is conducted on the basis of patch history information (patch state) collated by the patch tracker module 502 and information regarding the newly provisioned server obtained by the new server detector module 504. Patch controller module 508 controls the application of the selected patches to the newly provisioned server. Finally, joining controller module 510 causes the newly provisioned and patched server to be joined (i.e., go live) to the server cluster, but only once the patches have been applied.

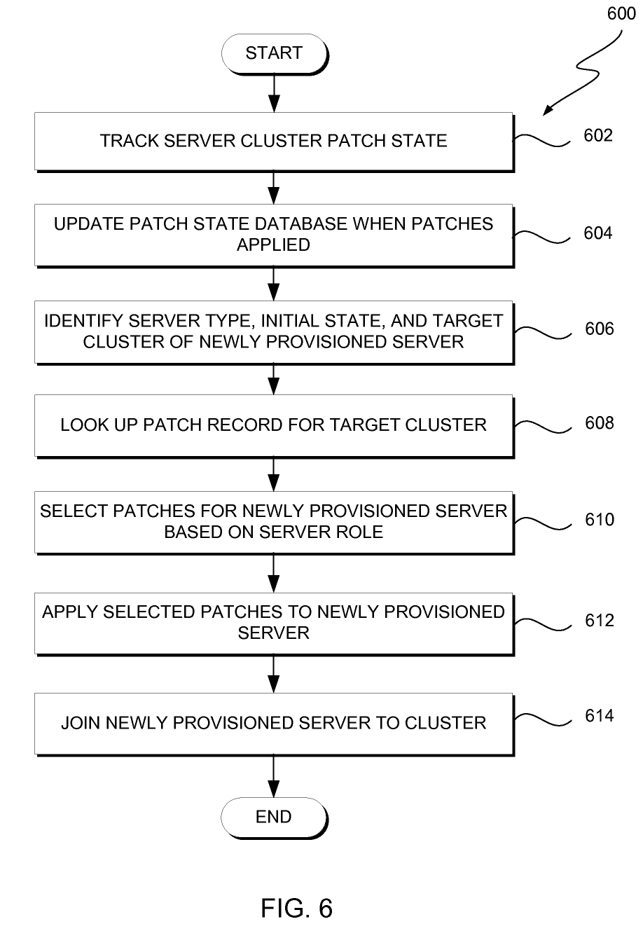

FIG. 6 illustrates operational processes of patch tracking program 104 utilizing patch state database 106, on computing device 102 within the environment of FIG. 1, in accordance with a first exemplary embodiment of the present invention.

According to various embodiments of the present invention, step 602 depicts patch tracking program 104 tracking the application of one or more patches being applied to one or more servers in a server cluster instance, and if so, the patch state for those newly patched servers is updated into patch state database 106 by patch tracking program 104 (step 604).

In step 606, patch tracking program 104 determines whether a new server has been recently provisioned, and if so the server type, initial state and target cluster for the newly provisioned server are identified by patch tracking program 104.

In step 608, patch tracking program 104 uses the identified server type and optionally the initial state to look up patch records for the target server cluster in patch state database 106.

At step 610, patch tracking program 104 selects one or more patches for the newly provisioned server in order that it will have substantially the same code level as the existing servers within the target cluster. For example, if the newly provisioned server is a file server having an initial state of V1.01 (from FIG. 4) it can be seen that similar servers (i.e., the servers having IDs 0001 and 0004) have been updated with patches X and Y. If multiple different servers have the same type, but have different initial software states, then patch tracking program 104 chooses a patch sequence corresponding to an existing server having both the same type and the same initial state as the newly provisioned server. In some implementations the initial state does not influence the patches to be applied to newly provisioned servers, in which case a determination of a patch sequence is based only on the newly provisioned server type. The identified patches, and an order in which they were applied to existing servers, are selected by patch tracking program 104.

In step 612, patch tracking program 104 applies the selected patches to the newly provisioned server.

In step 614 the provisioned and patched server is joined to the cluster by patch tracking program 104 and permitted to start performing its intended function in conjunction with the pre-existing servers in the cluster. Generally, from FIG. 6, it will be understood that the sequence of patches applied to existing servers is recorded in association with a role of the servers to which that sequence of patches has been applied, and that subsequently applying patches to a newly provisioned server includes identifying a role for the newly provisioned server and applying a sequence of patches which have been applied to existing servers having that role. In various embodiments, the sequence of patches applied by patch tracking program 104 to existing servers is recorded in association with an initial software state for the servers prior to patches being applied. Subsequently applying patches to the newly provisioned server may include identifying an initial software state of the newly provisioned server, and applying a sequence of patches which have been applied to existing servers having that same initial software state.

FIG. 7 illustrates operational processes of patch tracking program 104 utilizing patch state database 106, on computing device 102 within the environment of FIG. 1, in accordance with a second exemplary embodiment of the present invention.

In step 702, patch tracking program 104 determines whether a new patch has been applied to one or more servers, and if so, the patch records for those newly patched servers are updated by patch tracking program 104 in step 704.

At a step 706, patch tracking program 104 determines whether a new server has been recently provisioned, and if so the initial state and target cluster for the newly provisioned server are identified by patch tracking program 104 in step 706. In step 708, patch tracking program 104 uses the identified target cluster and optionally initial state to look up a matching patch record. In step 710 patch tracking program 104 identifies from the patch records a sequence of patches which can be applied to the newly provisioned server in order for it to have substantially the same code level as the existing servers within the target cluster. The identified patches, and an order in which they were applied to existing servers, are selected by patch tracking program 104. In step 712, patch tracking program 104 applies the selected patches to the newly provisioned server, following which in step 714 the provisioned and patched server is joined to the cluster and permit to start performing its intended function in conjunction with the pre-existing servers in the cluster.

It will be appreciated that in this embodiment, patch tracking program 104 identifies a suitable patch sequence based on the sequence of patches previously applied to the servers within the server cluster to which the newly provisioned server is to be joined. Where appropriate, the initial state of the newly provisioned server can be matched against the initial states of different ones of the servers in the cluster having different initial software states and different patch sequences to obtain the patch sequence which will result in a consistent code level. Generally, from FIG. 7 it will be understood that the sequence of patches applied to existing servers may be recorded in association with a server cluster to which those existing servers belong, and when applying patches to a newly provisioned server, a server cluster to which the newly provisioned server is to be joined can be identified, and a sequence of patches which have been applied to existing servers within that server cluster can be used to patch the newly provisioned server.

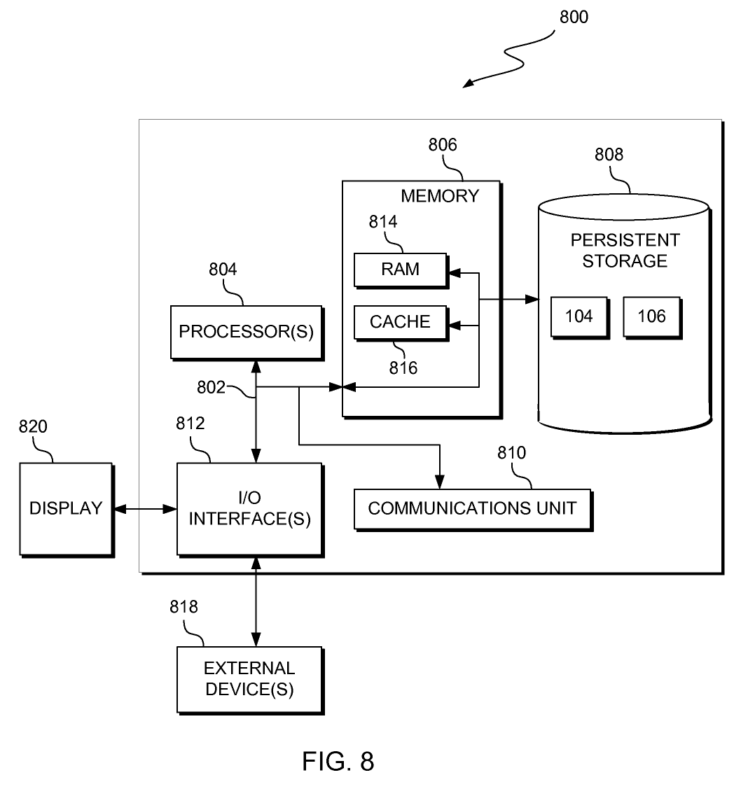

FIG. 8 depicts a block diagram, 800, of components of computing device 102, in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

Computing device 102 includes communications fabric 802, which provides communications between computer processor(s) 804, memory 806, persistent storage 808, communications unit 810, and input/output (I/O) interface(s) 812. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 814 and cache memory 816. In general, memory 806 can include any suitable volatile or non-volatile computer-readable storage media.

Patch tracking program 104 and patch state database are stored in persistent storage 808 for execution and/or access by one or more of the respective computer processors 804 via one or more memories of memory 806. In this embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer-readable storage medium that is also part of persistent storage 808.

Communications unit 810, in these examples, provides for communications with other data processing systems or devices, including resources of network 199. In these examples, communications unit 810 includes one or more network interface cards. Communications unit 810 may provide communications through the use of either or both physical and wireless communications links. Patch tracking program 104 and patch state database 106 may be downloaded to persistent storage 808 through communications unit 810.

I/O interface(s) 812 allows for input and output of data with other devices that may be connected to computing device 102. For example, I/o interface 812 may provide a connection to external devices 818 such as a keyboard, keypad, a touch screen, and/or some other suitable input device. External devices 818 can also include portable computer-readable storage media such as, for example, thumb drives, portable optical or magnetic disks, and memory cards. Software and data used to practice embodiments of the present invention, e.g., patch tracking program 104 and patch state database 106, can be stored on such portable computer-readable storage media and can be loaded onto persistent storage 808 via I/O interface(s) 812. I/O interface(s) 812 also connect to a display 820.

Display 820 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as “Smalltalk” and the like may be subject to trademark rights in various jurisdictions throughout the world and are used here only in reference to the products or services properly denominated by the marks to the extent that such trademark rights may exist.

1. A method comprising:
i) prior to a request to add a newly provisioned server to a first server cluster within a plurality of server clusters:
receiving, by one or more processors, one or more patch state updates to at least the first server cluster within the plurality of server clusters, wherein the first server cluster within the plurality of server clusters contains one or more servers with a first code level; and
generating, by the one or more processors, an updated patch history for the plurality of server clusters, wherein the updated patch history includes a server ID field, a server type field, a server cluster ID field, a server cluster type field, a server initial state field, a server cluster initial state field, and a patch sequence field; and
ii) subsequent to the request to add the newly provisioned server to the first server cluster within the plurality of server clusters:
based, at least in part, on the updated patch history, determining, by the one or more processors, one or more first patches and a first patch application sequence that will bring the newly provisioned server up to the first code level; and
applying, by the one or more processors, the one or more first patches to the newly provisioned server in a sequence dictated by the first patch application sequence.

2-3. (canceled)

4. The method of claim 1, wherein determining, by the one or more processors, the one or more first patches is dependent on:
a server type;
a server initial state; and
a target server cluster.

5. The method of claim 4, wherein the server type further comprises:
a web server, a file server, a print server, a database server, and a messaging server.

6-7. (canceled)

8. A computer program product comprising:
one or more computer-readable storage media and program instructions stored on at least one of the one or more computer-readable storage media, the program instructions comprising:
i) prior to a request to add a newly provisioned server to a first server cluster within a plurality of server clusters:
program instructions to receive one or more patch state updates to at least the first server cluster within the plurality of server clusters, wherein the first server cluster within the plurality of server clusters contains one or more servers with a first code level; and
program instructions to generate an updated patch history for the plurality of server clusters, wherein the updated patch history includes a server ID field, a server type field, a server cluster ID field, a server cluster type field, a server initial state field, a server cluster initial state field, and a patch sequence field; and
ii) subsequent to the request to add the newly provisioned server to the first server cluster within the plurality of server clusters:
based, at least in part, on the updated patch history, program instructions to determine one or more first patches and a first patch application sequence that will bring the newly provisioned server up to the first code level; and
program instructions to apply the one or more first patches to the newly provisioned server in a sequence dictated by the first patch application sequence.

9-10. (canceled)

11. The computer program product of claim 8, wherein program instructions to determine, by the one or more processors, the one or more first patches is dependent on:
a server type;
a server initial state; and
a target server cluster.

12. The computer program product of claim 11, wherein the server type further comprises:
a web server, a file server, a print server, a database server, and a messaging server.

13-14. (canceled)

15. A computer system comprising:
one or more computer processors;
one or more computer-readable storage media; and
program instructions stored on at least one of the one or more computer-readable storage media for execution by at least one of the one or more processors, the program instructions comprising:
i) prior to a request to add a newly provisioned server to a first server cluster within a plurality of server clusters:
program instructions to receive one or more patch state updates to at least the first server cluster within the plurality of server clusters, wherein the first server cluster within the plurality of server clusters contains one or more servers with a first code level; and
program instructions to generate an updated patch history for the plurality of server clusters, wherein the updated patch history includes a server ID field, a server type field, a server cluster ID field, a server cluster type field, a server initial state field, a server cluster initial state field, and a patch sequence field; and
ii) subsequent to the request to add the newly provisioned server to the first server cluster within the plurality of server clusters:
based, at least in part, on the updated patch history, program instructions to determine one or more first patches and a first patch application sequence that will bring the newly provisioned server up to the first code level; and
program instructions to apply the one or more first patches to the newly provisioned server in a sequence dictated by the first patch application sequence.

16-17. (canceled)

18. The computer system of claim 15, wherein program instructions to determine, by the one or more processors, the one or more first patches is dependent on:
a server type;
a server initial state; and
a target server cluster.

19. The computer system of claim 18, wherein the server type further comprises:
a web server, a file server, a print server, a database server, and a messaging server.

20-21. (canceled)

22. The method of claim 1, wherein the sequence dictated by the first patch application sequence is based, at least in part, on i) the one or more first patches to be applied to the newly provisioned server and ii) the order of applied patches for the at least one server of the first server cluster.

23. The computer program product of claim 8, wherein the sequence dictated by the first patch application sequence is based, at least in part, on i) the one or more first patches to be applied to the newly provisioned server and ii) the order of applied patches for the at least one server of the first server cluster.

24. The computer system of claim 15, wherein the sequence dictated by the first patch application sequence is based, at least in part, on i) the one or more first patches to be applied to the newly provisioned server and ii) the order of applied patches for the at least one server of the first server cluster.
